(19) United States
(12) Patent Application Publication
(10) Pub. No.: US 2015/0029005 A1
(43) Pub. Date: Jan. 29, 2015

(54) Remotely Activated Illuminated Shoe

(71) Applicant: JILL KIM, Los Angeles, CA (US)

(72) Inventor: JILL KIM, Los Angeles, CA (US)

(21) Appl. No.: 13/952,601

(22) Filed: Jul. 27, 2013

(51) Int. Cl. G08C 17/02; A43B 23/24

(52) U.S. Cl. CPC G08C 17/02; A43B 23/24
USPC 340/12.5

(57) ABSTRACT

An Improved Remotely Activated Illuminated Shoe includes a Chipset Assembly, a Actuator Assembly, a Connection Apparatus, and an LED Array. This Improved Remotely Activated Illuminated Shoe is used for the purpose of illuminating the shoe with a hand-held activation device such as a keychain whereby a portion of the shoe is illuminated in a variety of burst modes. In alternative embodiments, the lighting mechanisms can be carried out through apps executed on a smartphone or similar device.

### FIELD OF THE INVENTION

The present invention is in the area of footwear and more particularly pertains to an Improved Remotely Activated Illuminated Shoe for use with a hand-held activation device such as a keychain.

### CROSS REFERENCE

The present patent application is an improvement on pending U.S. patent application Ser. No. 13/708,926. The present invention incorporates by reference said pending application.

### BACKGROUND

In the fashion world, one of the staples of the industry is in footwear. Producing footwear is desirable due to the potentially high margins, as well as the attendant exposure, which can bring invaluable cachet and name recognition to the brand. But, as a consequence, competition is fierce, and the ability to stand out is difficult.

One way in which a manufacturer of footwear can stand out is through a lighting mechanism, which will light up various portions of a shoe. This stylish feature can be the cynosure upon which a shoe brand can market itself and carve out a niche in the marketplace.

Another way in which the lighting mechanism can become even more intriguing is to remotely activate and control various lighting modes of the shoe. This remote mechanism can be made even more interesting if it were to be embodied into unique devices.

### SUMMARY

In general, in a first aspect, the Improved Remotely Activated Illuminated Shoe features a Chipset Assembly, a Actuator Assembly, a Connection Apparatus, and an LED Array. Through the use thereof, a portion of the shoe is illuminated in a variety of burst modes. This remote-controlled lighting mechanism can incorporate a keychain assembly, which will activate the lighting mechanisms. In various implementations of an embodiment, the controls can be integrated into a mobile device such as a smartphone, tablet, smart-watch, etc.

The features and advantages described in this summary and the following detailed description are not all-inclusive. Many additional features and advantages will be apparent to one of ordinary skill in the art in view of the drawings, specification, and claims thereof.

### BRIEF DESCRIPTION OF THE DRAWING FIGURES

FIG. 1 is a side elevation view of an embodiment.

FIG. 2 is a schematic view of an embodiment.

FIG. 3 is a schematic view of an embodiment.

FIG. 4 is a schematic view of an embodiment.

FIG. 5 is a block diagram view of an embodiment.

FIG. 6 is a plan view of an embodiment.

FIG. 7 is a side elevation view of an embodiment.

### DETAILED DESCRIPTION

The present description incorporates by reference a Pending U.S. patent application Ser. No. 13/708,926. Various embodiments of the Improved Remotely Activated Illuminated Shoe are provided below.

For the purpose of the description below, the term “Burst Mode” shall refer to the frequency, if any that the LED Lights display. For instance, in various embodiments, the LED lights may display in a continuous mode. However, in other applications of an embodiment, the LED Lights may display in flashes, or “bursts”, whereby the lights can display as if they are blinking. The burst mode refers to the time intervals, and the frequency, if any, there are, and the time elapsed sequences between the bursts, which are predetermined and applied through the Main Circuit.

For the purposes of the description below, the term “Signal” shall further include magnetic fields, near-field technology, RFID's, etc., as well as radio waves, lasers, as well as audio waves.

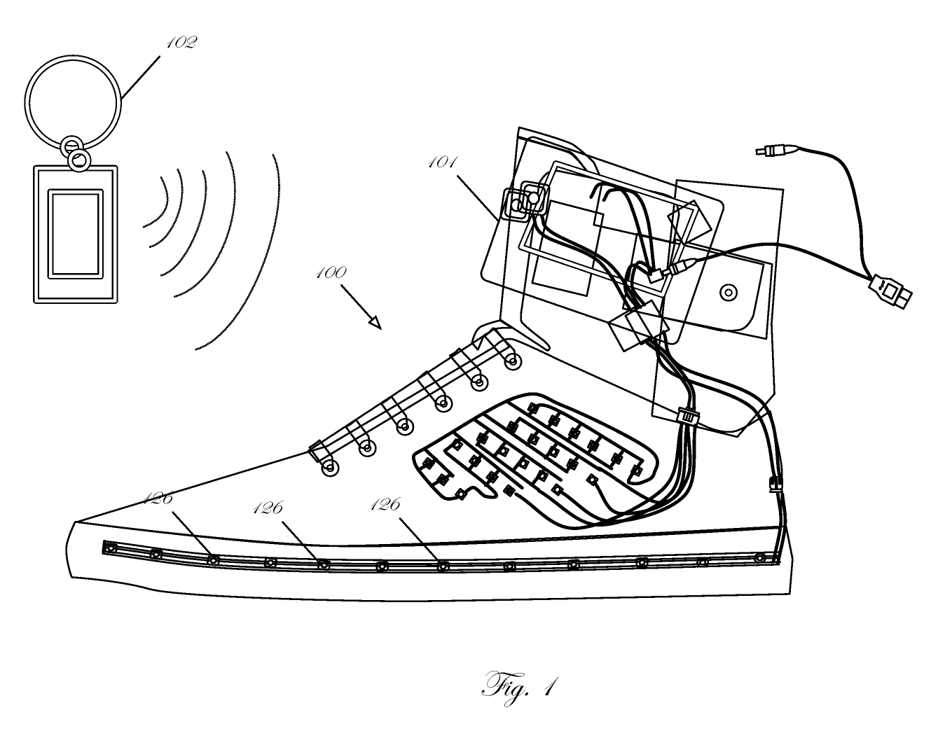

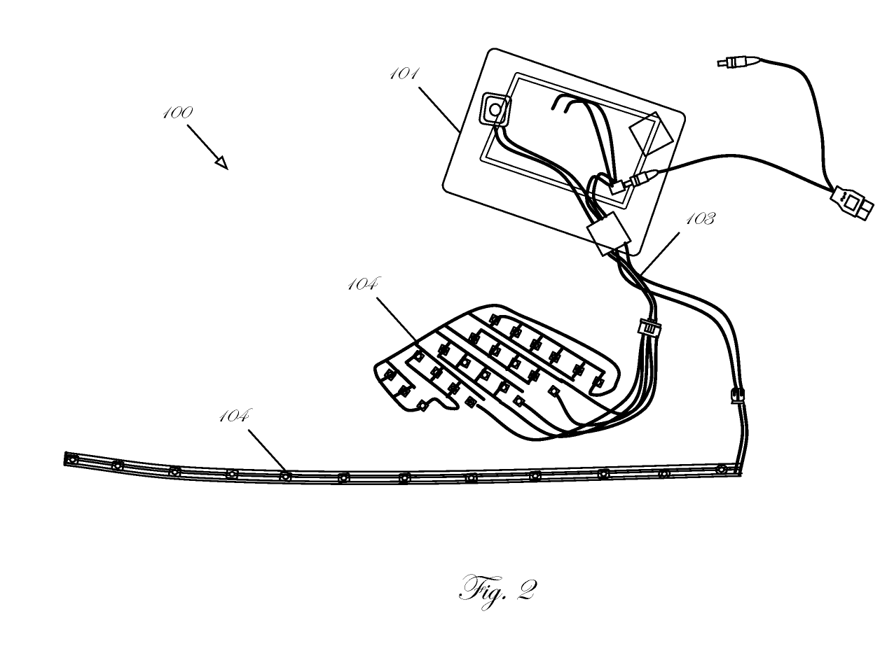

FIG. 1 illustrates that the Improved Remotely Activated Illuminated Shoe 100 includes a Chipset Assembly 101, an Actuator Assembly 102, a Connection Apparatus 103, and at least one LED Array 104. In various embodiments, one LED Array may be disposed along the periphery of the sole of the shoe, whereas another LED Array may be disposed on opposing mid-sectional regions of the shoe.

The Chipset Assembly 101 is used for the purpose receiving signals from the Actuator Assembly, processing those signals, and for activating and determining a burst mode. In one embodiment, the Chipset Assembly 101 is disposed within the tongue of a shoe. A zipper, or similar mechanism may retain the Chipset Assembly. The Chipset Assembly is in communication with the LED Arrays through a connection apparatus such as a wire. The LED Actuation Switch 103 is used for the purpose of providing the conduit between the Chipset Assembly and the LED Array.

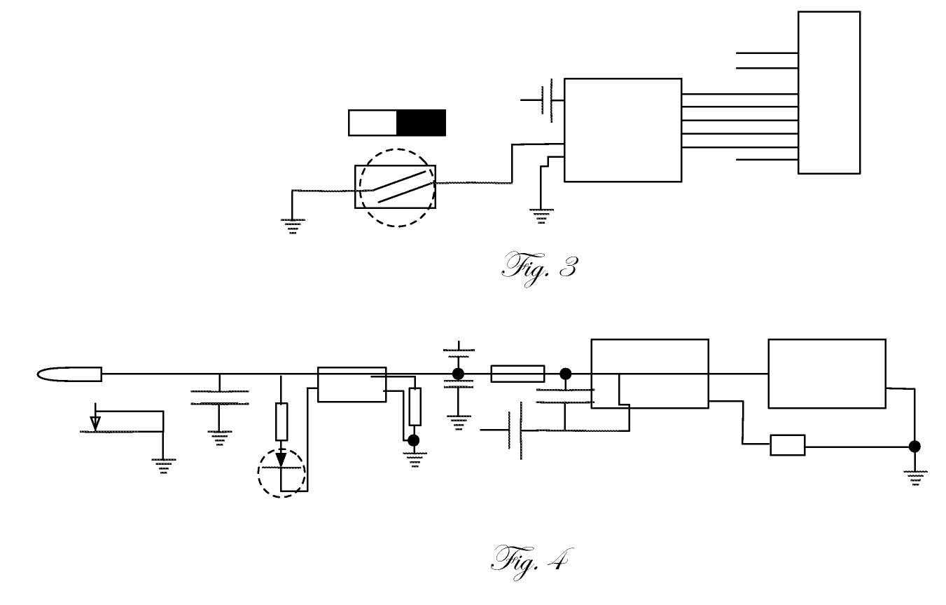

FIG. 1 illustrates that in various implementations of an embodiment, the Actuator Assembly 102 is embodied into a keychain. Also, the Actuator Assembly is in remote communication with the chipset assembly. FIGS. 3-4 illustrate that both the Chipset Assembly as well as the Actuator Assembly comprise logic integrated into circuits, which is enabled to transmit signals to the Chipset Box either through magnetic fields through use of simple magnets, or conducting electromagnetic fields, but also through other signals as well.

It should be noted here that the Actuator Assembly could be embodied into a panoply of forms other than the keychain. In various implementations of an embodiment, the Actuator Assembly, as well as its logic and program, can be executed on an app operating on a mobile device such as a smart phone, tablet, watch, or similar computer-based apparatus or system.

The Connection Apparatus 103 is used for the purpose of providing the conduit between the Chipset Assembly and the LED Array. Also, the Connection Apparatus is in communication with the LED Array and the Chipset Assembly.

The LED Array 104 is used for the purpose of illuminating the shoe in a variety of burst modes or a continuous mode. In one embodiment, the LED Array 104 is optionally disposed along a periphery of a sole of a shoe, or is disposed in a mid-sectional region of a shoe. Also, the LED Array is in communication with the Connection Apparatus. Moreover, in various implementations of an embodiment, the LED Array can be an assortment of different colors with various lighting features.

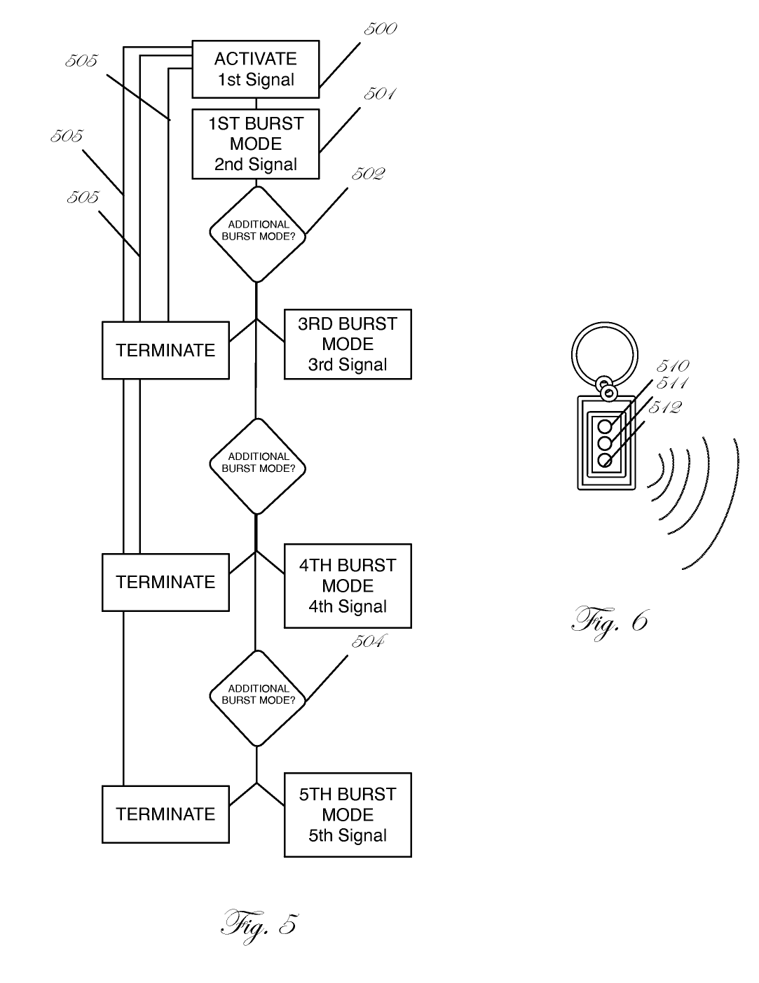

FIG. 5 illustrates one method, which can be embodied into the logic of the Main Circuit whereby the burst mode is determined through the successive signals generated from the keychain to the sensor.

In various implementations of an embodiment, the LED Actuation Switch may be responsive to a magnet, various signal transmitters such as an RFID Transmitter, near-field signals, etc. In addition, the LED Actuation Switch can determine the particular burst mode of the LED Array.

FIG. 5 illustrates in various implementations of an embodiment, that in a series of activations, the first signal 500 may activate the LED Arrays to light up. The second signal 501 may activate a particular flash mode at a predetermined burst rate. For instance, the first swiping of a magnetic field emitting from the keychain may activate a “flash” mode where the LED lights blink quickly at a predetermined rate. And in a successive optional step, a signal may either terminate if there are no more predetermined burst rates, which are programmed into the logic of the main circuit. However, if there is another pre-defined burst mode available, then the successive signal will actuate that burst rate. Additionally, this loop may continue ad infinitum as per the number of pre-defined burst rates. Upon the penultimate decision step 504, the loop may terminate in a signal that will discontinue power to the LED Arrays.

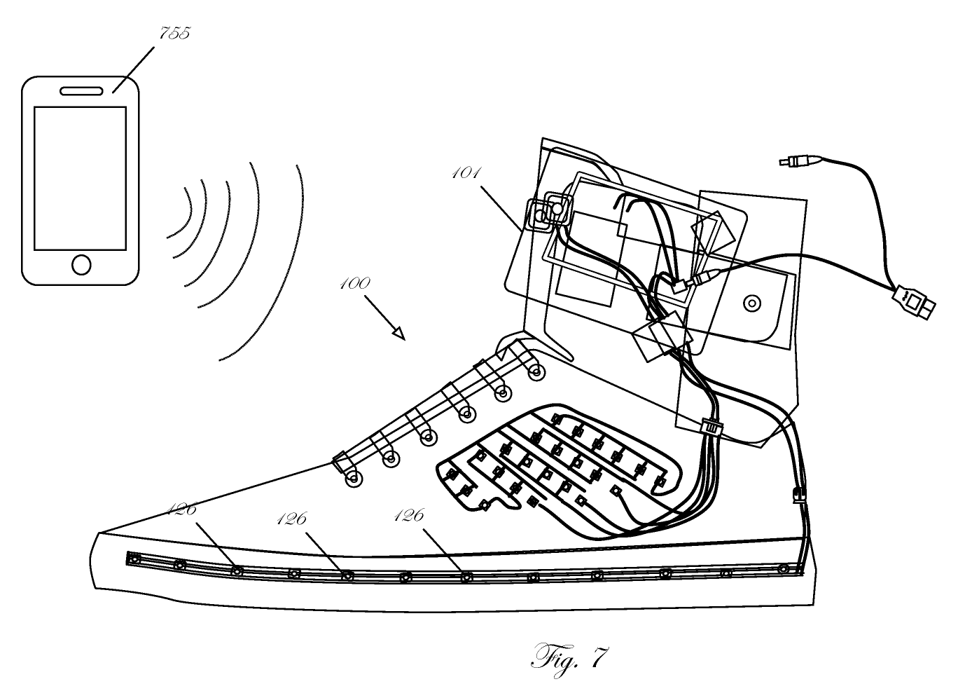

FIG. 6 illustrates in various implementations of an embodiment, the keychain may further comprise a plurality of buttons. Each button corresponds to a predetermined signal, which will correspond to a particular burst rate. Also, there may be one button corresponding to an “on” switch, and one for termination.

FIG. 7 illustrates in an alternative embodiment, that the Actuator Assembly may be embodied into an app executed on a smart phone 755, tablet, watch, or other mobile device executing apps. The smart phone can be in communication with the chipset box to display various burst rates. It can also be used to conserve energy in the event that the lights are not turned off when not in use. In another instance, the smartphone may automatically activate or turn the lights on at night when it is dark, or if a child has gone missing. Other uses abound when used in conjunction with logic integrated into a smartphone.

It will be apparent to the skilled artisan that there are numerous changes that may be made in embodiments described herein without departing from the spirit and scope of those embodiments. As such, the embodiments taught herein by specific examples are limited only by the scope of the claims that follow.

What is claimed is:

1. An Improved Remotely Activated Illuminated Shoe comprising:
a Chipset Assembly for the purpose of activating and determining a burst mode, an Actuator Assembly for the purpose of actuating the LED Array and for choosing the display burst mode for the LED Array, a Connection Apparatus for the purpose of providing the conduit between the Chipset Assembly and the LED Array, at least one LED Array optionally disposed along a periphery of a sole of a shoe, or is disposed in a mid-sectional region of a shoe for the purpose of illuminating the shoe in a variety of burst modes or a continuous mode;
the Chipset Assembly comprises a Housing, a Recharging Assembly, a Main Circuit, an LED Actuation Switch, and an Actuation Sensor;
the Chipset Assembly in communication with the LED Array through a connection apparatus;
the Actuator Assembly in remote communication with the chipset assembly;
the Connection Apparatus in communication with the LED Array and the Chipset Assembly;
the LED Array in communication with the Connection Apparatus.

2. The Improved Remotely Activated Illuminated Shoe of claim 1 wherein the Actuation Assembly comprises a keychain and a remote transmitter.

3. The Improved Remotely Activated Illuminated Shoe of claim 1 wherein the Recharging Assembly comprises an Adapter, a Recharging Plug, a Recharging Circuit, and a Light Indicator.

4. The Recharging Assembly of claim 3 wherein the Actuator Assembly having a disposed in an upper region of a shoe.

5. The Improved Remotely Activated Illuminated Shoe of claim 2 wherein the remote transmitter is a signal transmitter.

6. The Improved Remotely Activated Illuminated Shoe of claim 1 wherein the LED Array having a optionally disposed along a periphery of a sole of a shoe, or is disposed in a midsectional region of a shoe.

7. The Improved Remotely Activated Illuminated Shoe of claim 1 wherein the remote transmitter is a magnet.

8. The Improved Remotely Activated Illuminated Shoe of claim 1 wherein the LED Arrays are activated by a first transmission from the Actuation Assembly.

9. The Improved Remotely Activated Illuminated Shoe of claim 1 wherein the LED Arrays are activated to operate in a predetermined burst mode by a subsequent transmission from the Actuation Assembly.

10. The Improved Remotely Activated Illuminated Shoe of claim 1 wherein the LED Arrays are deactivated by a predetermined transmission from the Actuation Assembly.

11. The Improved Remotely Activated Illuminated Shoe of claim 1 wherein the Actuator Assembly is incorporated into an app executed on a mobile device.
